(19) United States
(12) Patent Application Publication
(10) Pub. No.: US 2006/0119095 A1
(43) Pub. Date: Jun. 8, 2006

(54) Turkey scoring system

(76) Inventor: Bernard P. Heffernon, Overland Park, KS (US)

Correspondence Address: POLSINELLI SHALTON WELTE SUELTHAUS P.C., 700 W. 47TH STREET, SUITE 1000, KANSAS CITY, MO, 64112-1802, US

(21) Appl. No.: 11/007,564

(22) Filed: Dec. 8, 2004

(51) Int. Cl. G09B 19/22

(52) U.S. Cl. 283/48.1

(57) ABSTRACT

The present invention relates to a scoring card that incorporates a scoring system for use in scoring game turkeys according to established scoring standards.

### FIELD OF INVENTION

The present invention relates to a measurement device and scoring system for use in scoring game turkeys according to established scoring standards.

### BACKGROUND OF INVENTION

Hunting has been an American past time for centuries. Originally hunting was a necessity for the procurement of food, but over time has developed into a sport that is enjoyed not only in America but also throughout the world. With the transition of hunting into a sport, a system for comparing the game animal is required.

The scoring system used to rate turkeys has been universally adopted to correspond to physical attributes. For determining the game turkey's “total score” first measurements are taken, which include the turkey's weight, beard length, and right and left spur length. Each measurement is then converted to a point total and tabulated to give the turkey's “total score.” The point standards are based on the current turkey scoring standards implemented by the National Wild Turkey Federation (NWTF) and universally followed by hunters.

Currently, scoring of the game turkey is difficult and cumbersome. Typically, a user is required to use a flexible measuring tape, a scale, and a scratch pad for recording the various measurements. The user then must look up the conversion factors for converting the measurements to the NWTF point standards for scoring. After the measurements are converted the point totals are tabulated and the “total score” is determined. Because of the numerous steps in this conventional process and the difficulty that a user may encounter if they attempt to measure the turkey alone, an accurate score is difficult to obtain.

It is therefore desired to have a turkey scoring system or card that includes the following features: 1) provides all the tools required for obtaining length measurements; 2) incorporates easy to follow scoring guides; 3) includes point conversion means based on the universal standards for tabulating the score of the turkey; 4) is a simplified scoring system that is easy to use; and, 5) can be easily transported by the user for use in calculating the “total score” of a game turkey.

### SUMMARY OF INVENTION

The present invention relates to a turkey scoring card that allows a user to easily score a turkey. The scoring card incorporates a system that includes at least one scoring sheet member, which provides all the required measurement conversions to easily tabulate a turkey's total score. The scoring system includes a sheet member with scale indicia for use in measuring the turkey's beard length and spur lengths. The scale indicia are configured to include the conversion to points that are universally adopted for scoring a turkey based on the NWTF standards. The scoring system also includes instruction indicia that provide step-by-step instructions for the user on how to properly obtain the turkey's measurements, convert the measurements to points, and tabulate the points to determine the turkey's total score. To assist in determining the spur lengths of the turkey, an elongated flexible member is removeably attached to the scoring card. The removeable attachment allows the user to easily measure the length of the right and left spurs and determine the points scored. The scoring card further includes conversion indicia for easily converting the turkey's measurements to points and tabulation indicia for use in recording the points scored for each measurement and totaling the points to determine the turkey's total score.

The scoring card is configured to be foldable and can be collapsed to allow the user to easily transport the scoring card and therefore allows the user to score the turkey while still in the field. Further, the scoring card is composed of material that allows the scoring card to be used in various environmental conditions including rain and snow.

### BRIEF DESCRIPTION OF DRAWINGS

FIG. 1 is an elevation view of a first side of the first embodiment of the scoring card;

FIG. 2 is an elevation view of a second side of the first embodiment of the scoring card;

FIG. 3 is a perspective view of the first embodiment shown in exemplary use being folded;

FIG. 4 is an elevation view of a first side of an optional embodiment of the scoring card;

FIGS. 5 and 6 is a perspective view of an optional embodiment shown in exemplary use being slid.

FIG. 7 is an elevation view of a first side of an optional embodiment of the scoring card;

FIG. 8 is perspective view of an optional embodiment shown in exemplary use with a sheet member being rotated on the axis.

### DETAILED DESCRIPTION

The present invention relates to a turkey scoring card or system so that a turkey can be easily scored based on universal turkey scoring standards. The scoring system includes at least one scoring sheet member that includes indicia and an elongated flexible member.

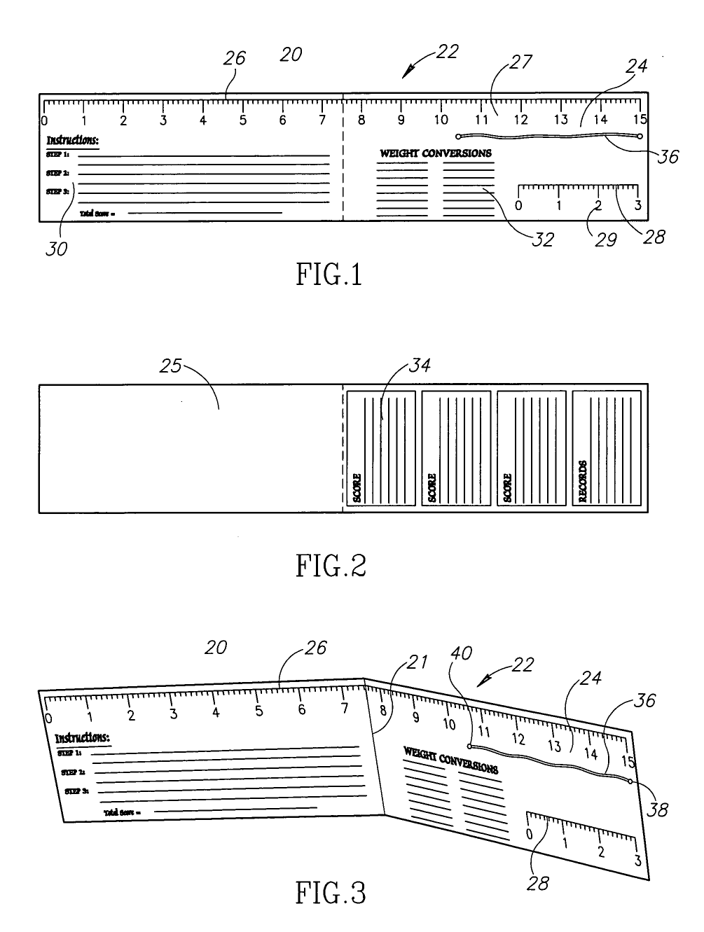

FIGS. 1 through 3 disclose a first embodiment of a turkey scoring system 20. The sheet member 22 of the scoring system 20 is configured to include indicia for scoring a turkey. Species of turkeys currently scored by users include but are not limited to Eastern, Florida, Rio Grande, Merriams, Goulds, and Occelated. The indicia will correspond to the current standards recognized in the industry for scoring a turkey. Preferably, the scoring of the turkey will be based on the current NWTF standards, which have been universally adopted by those in the art for scoring a wild turkey. The NWTF standards for scoring a turkey include the conversion of the weight, beard length, and spur length measurements into points. The points are then totaled to determine the score for the turkey. The points for the weight correspond to the weight of the turkey in pounds and ounces. Each pound is worth one point and ounces are converted into decimals. The points for the spur length are based on the total length of the right and left spur multiplied times ten (10). The spur length is measured to the nearest 1/16 inch along the outside center of each spur, from the point at which the spur protrudes from the scaled leg skin to the tip of the spur. Fractions of an inch are converted to decimals. The points for the beard length are based on the total length of the beard multiplied times two (2). The beard length is measured to the nearest 1/16 inch from the center point of the protrusion from the skin to the end of the longest bristle. Fractions of an inch are converted to decimals. If the turkey is considered a non-typical type, which is a turkey with two or more beards, each beard is measured and converted to points. Optionally, the indicia can be any scoring standards known in the industry.

The sheet member 22 will preferably include a first side 24 (FIG. 1) and a second side 25 (FIG. 2). The sheet member 22 will include scale indicia 26 and 28. The scale indicia 26 is a ruler configured for measuring a turkey's beard. Preferably, the scale indicia 26 is configured with conversion indicia 27 to convert the turkey's beard measurement to points, based on the NWTF standards. The inclusion of the conversion indicia 27 aids the user in easily obtaining the beard score that will be used to calculate the overall score of the turkey. The scale indicia 28 is a ruler that is configured for measuring a turkey's spurs. Preferably, the scale indicia 28 is configured with conversion indicia 29 to convert the turkey's spur measurements to points, based on the NWTF standards. The inclusion of the conversion indicia 29 aids the user in easily obtaining the point totals for the spur length that is used to calculate the overall score of the turkey.

Optionally, the sheet member will include a conversion mechanism for converting the beard length, the spur lengths, and weight measurements to the points used by the NWTF for scoring a turkey. The conversion mechanism will operate by converting the measurements taken from the turkey into the point system used by the NWTF. Preferably, the conversion mechanism will be conversion indicia 27 and 29 that is incorporated into the scale indicia 26 and 28. Optionally, the conversion mechanism can be a chart or any means for displaying the points corresponding to each measurement. Optionally, the conversion mechanism is a rotatable or slideable conversion mechanism that allows easy measurement conversions to points.

The sheet member will include instruction indicia 30. The instruction indicia 30 will outline for the user how to properly tabulate the turkey's score. The instruction indicia 30 will provide a step-by-step guide to assist the user in gathering the needed scoring measurements or points and how to tabulate the points once they are obtained. The instruction indicia 30 will preferably incorporate the scoring standards used by the NWTF, and previously discussed.

The sheet member 22 will optionally include weight conversion indicia 32. The weight conversion indicia 32 will assist the user in easily converting the turkey's weight, specifically the ounces, into the points used to score the turkey.

The instruction indicia 30 will include scoring tabulation indicia 34. The tabulation indicia 34 will provide a place for the user to input the scores obtained from the turkey, including the weight score, the beard score, the right spur score, and the left spur score. Preferably, the tabulation indicia 34 will include a total score line, which assists the user in totaling the score for the turkey. Optionally, the tabulation indicia 34 will include a place to record the date, location, and type of turkey.

The sheet member 22 is composed of any material known in the industry. Preferably, the sheet member 22 is a plastic-coated paper. The plastic-coated sheet member 22 facilitates the use of the turkey scoring system 20 of the present invention, by allowing it to be used in various environmental conditions, including rain and snow. The plastic-coated sheet member 22 also allows the user to record scores and later erase the scores entered in the tabulation indicia 34 enabling the user to repeatedly use the tabulation indicia 34 and the turkey scoring system 20. Optionally, the sheet member can be composed of paper, plastic, wood, metal, fabric, coated foam, cardboard, and combinations thereof.

Preferably, the sheet member 22 is configured to be foldable (FIG. 3). The sheet member 22 is foldable to allow the length of the sheet member 22 to be reduced so the sheet member 22 and turkey scoring system 20 can be easily transported by the user when not in use. Preferably, the sheet member 22 is scored in the middle of the sheet member 20 to create a single fold 21 line to assist in the folding.

The turkey scoring system 20 also includes an elongated flexible member 36. The elongate flexible member is configured to assist the user in measuring the length of the spur. The member 36 is composed of any material known in the art that is flexible and allows the member 36 to be used to assist in determining the length of the turkey's spurs. The member 36 is greater than one (1) inch in length. Preferably, the member 36 is between 3 inches and 10 inches. The length of the member 36 is long enough to easily measure the length of each turkey spur. Preferably, the member is composed of plastic, metal cable, string, fabric, nylon, and combinations thereof. Optionally, the member 36 will include scale indicia for use in measuring the length of the turkey's spurs.

The member 36 is attached to the sheet member 22 by any means known in the art. Preferably, the member 36 is removeably attached to the sheet member 22 by any means known in the art. The removeably attached member 36 can be attached by reusable tape, reusable glue, a slot in the sheet member 22, a button, a clip, a snap, and combinations thereof.

Optionally, at least one end 38 of the member 36 is fixedly attached to the sheet member 22 by any means known in the art. The fixedly attached end 38 can be attached by tape, glue, a ring, a rivet, and combinations thereof. The fixedly attached end 38 ensures that the member 36 is always connected to the turkey scoring system and will not be lost. Optionally, at least one end 40 of the member 36 is removeably attached to the sheet member 22 by any means known in the art. The removeably attached end 40 can be attached by reusable tape, reusable glue, a slot in the sheet member 22, a button, a clip, a snap, and combinations thereof.

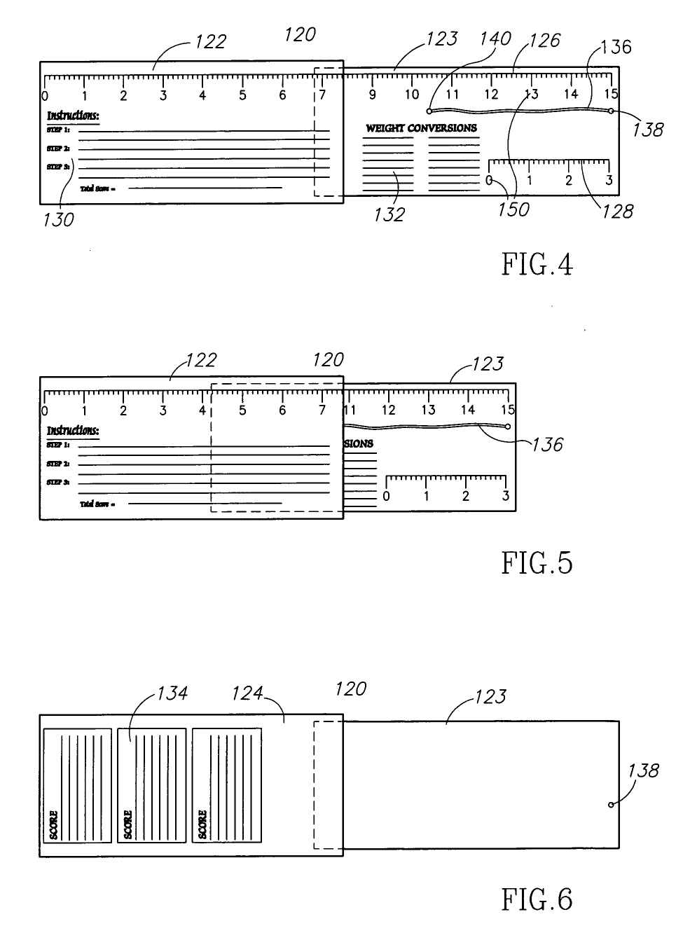

FIGS. 4 through 6 disclose an optional embodiment of the present turkey scoring system 120. This embodiment is configured to include at least three sheet members 122, 123, and 124. The sheet member 123 is configured intermediate sheet members 122 and 124. The sheet member 123 is configured to slide between the sheet members 122 and 124 to allow the turkey scoring system 120 to be expanded for use in scoring the turkey or collapsed when the scoring system 120 is not in use. Preferably, the sheet member 123 will slide until it reaches a determined point where the scale indicia 126 correlate to create a continuous scale indicia 126.

The sheet members 122, 123, and 124 will include the indicia as described in the preferred embodiment, including scale indicia 126 and 128, conversion indicia 150, instruction indicia 130, weight conversion indicia 132, and tabulation indicia 134.

The sheet members 122 through 124 are composed of any material known in the industry. Preferably, the sheet members 122 through 124 are plastic-coated paper. The sheet members 122 through 124 are configured according to the specifications outlined above for the sheet member 22.

The turkey scoring system 120 also includes an elongated flexible member 136. The elongated flexible member 136 is configured according to the specifications outlined above for the elongated flexible member 36. Preferably, the member 136 is removeably attached to the turkey scoring system 120 by any means known in the art. The member 136 can be attached by reusable tape, reusable glue, a slot in the sheet, a button, a clip, a snap, and combinations thereof. Optionally, at least one end 138 of the member 136 is fixedly attached to the turkey scoring system 120. The fixedly attached end 138 can be attached by tape, glue, a ring, a rivet, and combinations thereof. Further, end 140 of the member 136 is removeably attached to the turkey scoring system 120 by any means known in the art. The removeably attached end 140 can be attached by reusable tape, reusable glue, a slot in the sheet, a button, a clip, a snap, and combinations thereof.

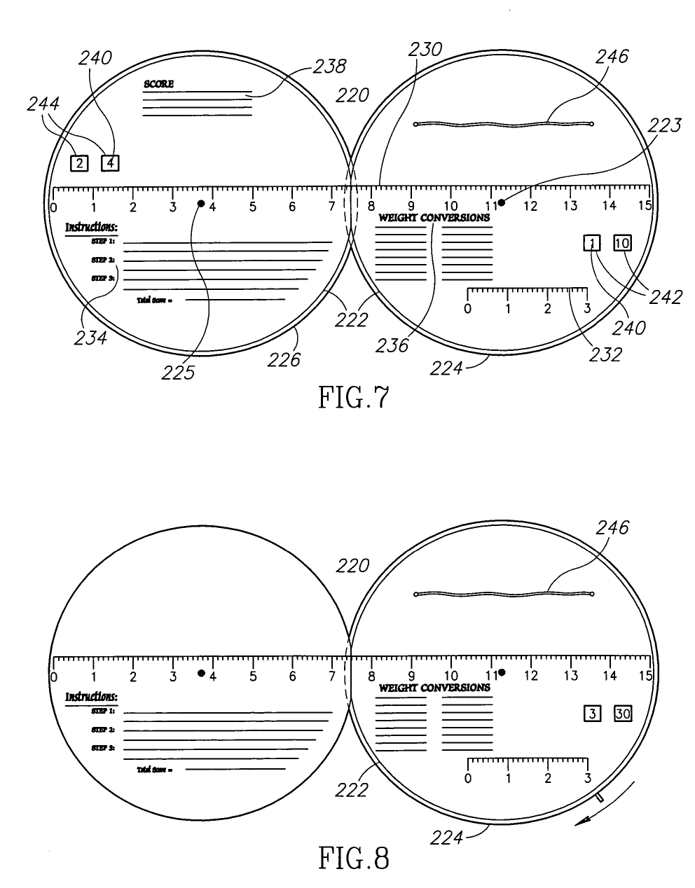

FIGS. 7 and 8 discloses an optional embodiment of the present turkey scoring system 220. This embodiment is configured to include at least two sheet members 222 and 224. The sheet member 224 is rotatably attached to sheet member 222 at axis 223. The attachment of the sheet member 224 at the axis 223 allows the sheet member 224 to rotate in a clockwise or counterclockwise motion in relationship to sheet member 222. Optionally, additional sheet members, such as sheet member 226 may be rotatably attached to sheet member 222. The sheet members 224 and 226 are rotatably attached to sheet member 222 by any means known in the art. Preferably, the attachment is through the use of a rivet, a snap, a button, and combinations thereof.

The sheet member 222 will further include openings 242 and 244. The openings 242 and 244 are holes in the sheet member 222 that allow the conversion indicia 240 on the sheet members 224 and 226 to be viewed by the user. The conversion indicia 240 allows the user to easily convert the length measurements taken from the turkey to the points used for scoring. The user rotates the sheet members 224 or 226 until the desired measurement and conversion points appear in the openings 242 or 244.

The sheet members 222, 224, and 226 will include the indicia as described in the preferred embodiment, including scale indicia 230 and 232, instruction indicia 234, weight conversion indicia 236, and tabulation indicia 238.

The sheet members 222, 224, and 226 are composed of any material known in the industry. Preferably, the sheet members are plastic-coated paper.

The sheet member 222 is configured to be foldable. The sheet member 222 is foldable to allow the length of the sheet members to be reduced for easy transportation.

The turkey scoring system 220, also includes an elongated flexible member 246. The elongated flexible member 246 is configured according to the specifications outlined above for the elongated flexible member 36. The member 246 is attached to the turkey scoring system 220 by any means known in the art and previously discussed above.

Thus, there has been shown and described a turkey scoring system that fulfills all objects and advantages sought therefore. The invention illustratively disclosed herein suitably may be practiced in the absence of any element which is not specifically disclosed herein. It is apparent to those skilled in the art, however, that many changes, variations, modification, other uses, and applications to the turkey scoring system are possible, and also such changes, variations, modifications, other uses, and application which do not depart from the sprit and scope of the invention are deemed to be covered by the invention, which is limited only by the claims which follow.

What is claimed is:

1. A turkey scoring system comprising:
(a) at least one sheet member with a first and a second side;
(b) scale indicia for scoring a turkey included on the sheet member; and,
(c) an elongated flexible member attached to the sheet member.

2. The turkey scoring system of claim 1, wherein the sheet member is a foldable sheet member.

3. The turkey scoring system of claim 2, wherein the foldable sheet member is scored to allow easy folding.

4. The turkey scoring system of claim 1, wherein the scale indicia is configured for the measurement of a turkey's beard and left and right spur.

5. The turkey scoring system of claim 1, wherein the scale indicia is configured for tabulating points correlating to turkey scoring standards.

6. The turkey scoring system of claim 1, wherein the elongated flexible member is removeably attached to the sheet member.

7. The turkey scoring system of claim 1, wherein the elongated flexible member is composed of plastic, metal cable, string, fabric, and combinations thereof.

8. The turkey scoring system of claim 1, wherein the sheet member includes record keeping indicia for recording a plurality of measurements.

9. The turkey scoring system of claim 8, wherein the plurality of measurements include the points for the beard, the points for the weight, and the points for the left and right spur length.

10. The turkey scoring system of claim 8, wherein the record keeping indicia is configured on the second side of the sheet member.

11. The turkey scoring system of claim 1, wherein the sheet member is a plastic coated sheet member.

12. The turkey scoring system of claim 1, further including a second sheet member.

13. The turkey scoring system of claim 12, wherein the second sheet member is rotatably attached to the sheet member.

14. The turkey scoring system of claim 1, wherein the sheet member further includes conversion indicia for calculating the points for the beard, weight, and left and right spur length.

15. A turkey scoring system comprising:
(a) a sheet member configured for folding, that includes scale indicia configured for the measurement of a turkey's beard and right and left spur, conversion indicia for calculating the points for the beard length, weight, and right and left spur length, and record keeping indicia configured for recording a plurality of points scored, which correlate to the established turkey scoring standards to determine the total score; and,
(b) an elongated flexible member removeably attached to the sheet member.

16. The turkey scoring system of claim 15, wherein the elongated flexible member is composed of plastic, metal cable, string, fabric, and combinations thereof.

17. A turkey scoring system comprising:
(a) a first sheet member that includes scale indicia configured for the measurement of a turkey's beard and right and left spur, conversion indicia for calculating the points for the beard length, weight, and right and left spur length, and record keeping indicia configured for recording a plurality of points scored, which correlate to the established turkey scoring standards to determine the total score;
(b) a second sheet member rotatably attached to the first sheet member; and,
(c) an elongated flexible member removeably attached to the sheet member.

18. The turkey scoring system of claim 17, wherein the elongated flexible member is composed of plastic, metal cable, string, fabric, and combinations thereof.

19. The turkey scoring system of claim 17, wherein the first sheet is a foldable sheet member that is scored to allow easy folding.

20. A turkey scoring system comprising:
(a) a sheet member; and,
(b) an elongated flexible member removeably attached to the sheet member.
